(19) United States
(12) Patent Application Publication
(10) Pub. No.: US 2007/0129837 A1
(43) Pub. Date: Jun. 7, 2007

(54) IN-CIRCUIT TESTING AND REPAIRING SYSTEM FOR PCB

(75) Inventor: Zhi-Ping Zhang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,039

(22) Filed: Jun. 13, 2006

(30) Foreign Application Priority Data
Nov. 18, 2005 (CN) 200510101538.2

(51) Int. Cl. G06F 19/00

(52) U.S. Cl. 700/116; 700/105

(57) ABSTRACT

An in-circuit testing and repairing system for printed circuit boards includes an in-circuit testing device for testing printed circuit boards, a shop floor control system connected to the in-circuit testing device via a network for collecting and processing the test data produced by the testing device, and a repair station including an electronic device for displaying information of a faulty printed circuit board. The electronic device connected to the shop floor control system. The test data from the in-circuit testing device is automatically transferred to the shop floor via the network for processing, and the processed test data is sent back to the in-circuit testing device, the test data of the faulty printed circuit board is sent from the shop floor controlling system to the repair station.

### FIELD OF THE INVENTION

The present invention relates to in-circuit testing and repairing systems, more particularly to an in-circuit testing and repairing system for testing printed circuit board (PCB) online and showing information of products having flaws.

### DESCRIPTION OF RELATED ART

In-circuit testing is the most popular method for testing a printed circuit board in the manufacturing industry. The in-circuit testing system is used for checking the quality of the components on the PCB and finding short or open circuits on the PCB and providing a report of the flaws needing repair.

A typical in-circuit testing and repairing system includes an in-circuit testing device, a data collecting machine, a scanner connected to the data collecting machine, a shop floor control (SFC) system connected to the data collecting machine via a network, and a data storing module connected to the SFC system via the network. After a PCB is tested, the result is displayed on the testing device. Operators use the scanner to scan a barcode of the tested PCB and a special barcode representing different test data according to the test results. Then, the test data of the PCB is collected by the data collecting machine and is transmitted to the SFC system and the data storing module via the network, for controlling the manufacturing instance of the PCBs and checking the test results of the tested PCBs. The in-circuit testing and repairing system further includes a printer connected to the in-circuit testing device. Failed test results are printed out by the printer. Then an operator of a repair station repairs the faulty PCBs according to the printed results.

However, the test data is scanned into the data collecting machine manually, and is inefficient for a product line manufacturing mode. Furthermore, the manual operation may return imprecise test results. And, the printed data may be misunderstood by the operator or even misplaced.

What is needed, therefore, is an in-circuit testing and repairing system which can transmit the testing data automatically allowing repair of the faulty PCBs in a more efficient manner.

### SUMMARY OF THE INVENTION

An in-circuit testing and repairing system for printed circuit boards includes an in-circuit testing device for testing printed circuit boards, a shop floor control system connected to the in-circuit testing device via a network for collecting and processing the test data produced by the testing device, and a repair station including an electronic device for displaying information of a faulty printed circuit board. The electronic device connected to the shop floor control system. The test data from the in-circuit testing device is automatically transferred to the shop floor via the network for processing, and the processed test data is sent back to the in-circuit testing device, the test data of the faulty printed circuit board is sent from the shop floor controlling system to the repair station.

Other advantages and novel features will be drawn from the following detailed description of preferred embodiments with attached drawings, in which:

### BRIEF DESCRIPTION OF THE DRAWINGS

FIG. 1 is a block diagram of an in-circuit testing and repairing system of the preferred embodiment of the present invention, the in-circuit testing and repairing system including an in-circuit testing device, a shop floor control system, a repair station, and a data storing module;

FIG. 2 is a block diagram of the in-circuit testing device of FIG. 1;

FIG. 3 is a block diagram of the shop floor control system of FIG. 1;

FIG. 4 is a flow chart of the in-circuit testing and repairing system of FIG. 2; and

FIG. 5 is a flow chart of the testing data transferring process of the in-circuit testing and repairing system.

### DETAILED DESCRIPTION OF THE INVENTION

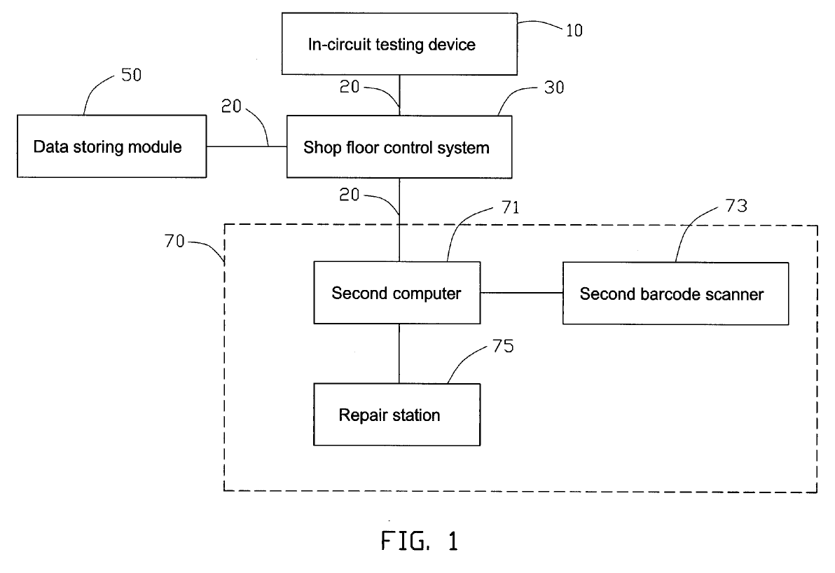

Referring to FIG. 1, an in-circuit testing and repairing system for testing and repairing an electronic/circuit assembly like a printed circuit board (PCB) in accordance with a preferred embodiment of the present invention, includes an in-circuit testing device 10, an SFC system 30, a data storing module 50, and a repairing system 70.

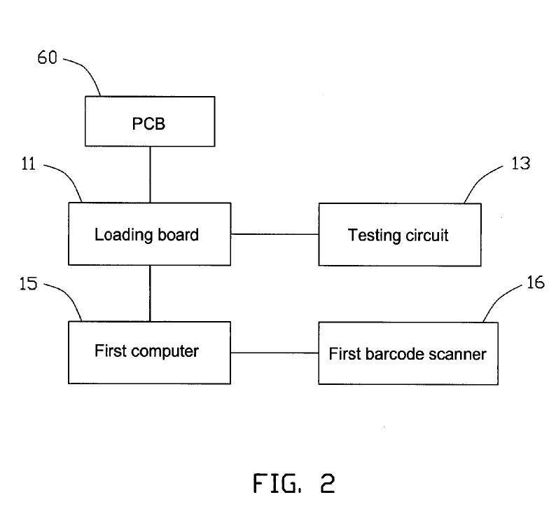

Referring also to FIG. 2, the in-circuit testing device 10 includes a loading board 11 for receiving a PCB 60, a plurality of testing circuits 13 for testing the components of the PCB 60, a first computer 15 connected to the loading board 11, and a first barcode scanner 16. The first computer 15 includes a suite of in-circuit testing software.

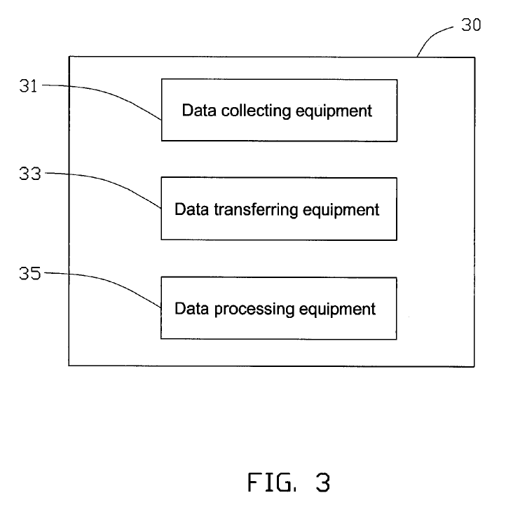

The SFC system 30 is connected to the first computer 15 via a network 20. Referring also to FIG. 3, the SFC system 30 includes a module incorporating a data collecting equipment 31, a data transferring equipment 33, and a data processing equipment 35. The test data produced by the in-circuit testing device 10 is uploaded to the SFC system 30 by the data collecting equipment 31, and then the test data is processed by the data processing equipment 35 to get a test result. The test result produced by the data processing equipment 35 is transmitted back to the first computer 15 of the testing device 10 for displaying on a monitor (not shown) of the first computer 15, so that an operator can judge whether the PCB 60 is OK.

The data storing module 50 is connected to the SFC system 30 via the network 20. The test results produced by the data processing equipment 35 are transmitted to the data storing module 50 to form a database.

The repairing system 70 includes a second computer 71, a second barcode scanner 73, and a repair station 75. The second computer 71 is connected to the SFC 30 also via the network 20 for displaying the test results of the faulty PCB 60. The second barcode scanner 73 is connected to the second computer 71 for reading the barcodes of the faulty PCBs 60 into the second computer 71. The faulty PCBs 60 are repaired at the repair station 75 according to the data displayed by the second computer 71.

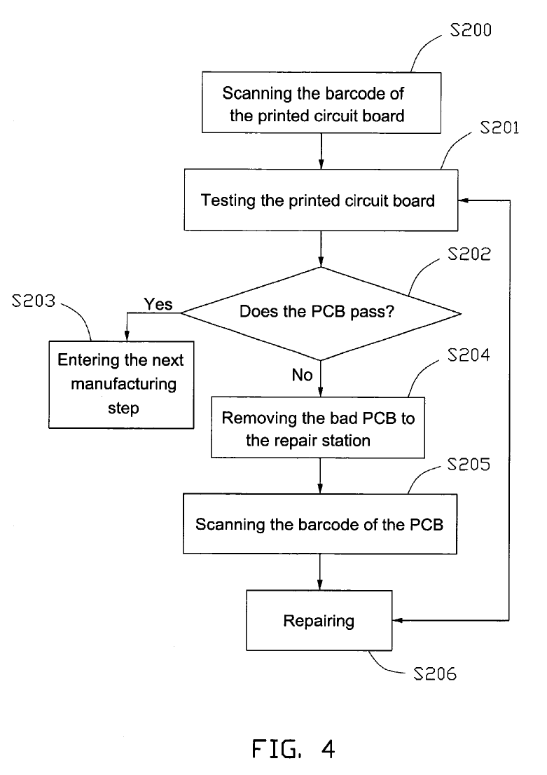

Referring also to FIG. 4, the working process of the in-circuit testing and repairing system includes a plurality of steps as follows:

Using the first barcode scanner 16 to scan the barcode of the PCB 60 for getting a series of static test data (step 200). The static test data includes the machine number of the testing device, product material numbers, operator numbers etc. The static test data is transferred via the network 20 according to the following steps: a. the static test data is transmitted to the SFC system; b. the SFC system collects and processes the static test data; c. the processed static test data is transmitted back to the first computer 15 for displaying; d. the static test data is stored in the data storing module 50.

Testing the PCB 60 (step 201). The components of the PCB 60 needing to be tested are respectively connected to the corresponding testing circuits 13, and the testing device 10 begins to test the selected components of the PCB 60 according to the predetermined parameters of a suite of software in the testing device 10. For instance, testing the resistance of a resistor or testing the capacitance of a capacitor, and etc. During the testing process, the in-circuit testing electronic device 10 produces a series of dynamic test data. The dynamic test data includes serial numbers of products, testing time, and testing position number etc. The dynamic data is transmitted via the network 20 according to the following steps: a. the dynamic test data is transmitted to the SFC system; b. the SFC system collects and processes the dynamic test data; c. the processed dynamic test data is transmitted back to the first computer 15; d. the dynamic test data is stored in the data storing module 50.

An operator decides if the PCB 60 is faulty according to the test data transmitted back to the first computer 15 (step 202).

If the PCB 60 tests good, then the PCB 60 can enter a next manufacturing step (step 203).

If the PCB 60 tests bad, it will be removed to the repairing system 70 for repairing (step 204).

Using the second barcode scanner 73 of the repairing system 70 to scan the barcode of the faulty PCB 60. The test data of the faulty PCB 60 will be displayed on the second computer 71 (step 205).

Repairing the faulty PCB 60 according to the data displayed on the second computer 71 of the repairing system 70 (step 206). Then, the system returns to the step 201 for testing the repaired PCB 60 again.

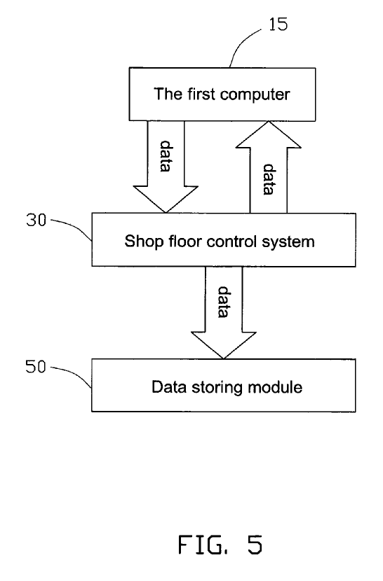

Referring to FIG. 5, the process for processing the static and dynamic test data includes a plurality of steps as follows: 1. identifying the testing code including the test data; 2. confirming the data transferring format according to the testing code; 3. transforming the testing codes to testing files. If the tested PCB 60 passes testing, the testing files are transferred to the in-circuit testing device 10 along with the information that the test resulted in a “PASS”; If the tested PCB 60 doesn't pass testing, the testing files transferred to the in-circuit testing device 10 include the information that the test resulted in a “FAIL”, and the test data of the faulty PCB 60 is listed on the first computer 15. 4. Producing various testing tables including the information of quantity of tested PCBs 60 and a rate or ratio of products passing testing. When the rate or ratio is lower than a predetermined value, the system sends a warning letter to the related department.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An in-circuit testing and repairing system for printed circuit boards, comprising:
an in-circuit testing device for testing printed circuit boards;
a shop floor control system connected to the in-circuit testing device via a network for collecting and processing test data produced by the in-circuit testing device; and
a repairing system comprising an electronic device for displaying information of faulty printed circuit boards failing to pass testing, the electronic device connected to the shop floor control system via the network;
wherein the test data from the in-circuit testing device is transferred to the shop floor control system via the network for processing, the processed test data is sent back to the in-circuit testing device, and the test data of the faulty printed circuit board is sent from the shop floor controlling system to the repair station.

2. The in-circuit testing and repairing system for printed circuit boards as described in claim 1, wherein the shop floor control system comprises a module incorporating a data collecting equipment, a data transferring equipment, and a data processing equipment.

3. The in-circuit testing and repairing system for printed circuit boards as described in claim 1, wherein the in-circuit testing device comprises a testing electronic device connected to the shop floor control system via the network for displaying the test data.

4. The in-circuit testing and repairing system for printed circuit boards as described in claim 3, wherein the in-circuit testing device comprises a first code scanner connected to the testing electronic device for scanning static test data into the testing electronic device.

5. The in-circuit testing and repairing system for printed circuit boards as described in claim 1, further comprising a second code scanner connected to the electronic device of the repair station for scanning a code of the faulty printed circuit board into the electronic device.

6. The in-circuit testing and repairing system for printed circuit boards as described in claim 1, further comprising a data storage module connected to the shop floor control system via the network for storing the test data of the printed circuit board from the shop floor control system.

7. A method for testing and repairing an electronic assembly, comprising the steps of:
creating static test data for identifying an electronic assembly to be tested;
processing said static test data for display;
retrieving dynamic test data when said electronic assembly is tested;
processing said dynamic test data for display;
verifying said static and dynamic test data through said display for identifying normality of said electronic assembly;
transmitting said static and dynamic test data of any electronic assembly to be tested identified as being abnormal to a repair station for repairing said any electronic assembly to be tested; and
repeating said above-defined retrieving step to said above-defined verifying step for said repaired any electronic assembly.

8. The method as described in claim 7, wherein both of said processing static and dynamic test data steps comprise the step of transforming said static and dynamic test data to testing files respectively.

9. The method as described in claim 8, wherein said processing dynamic test data step further comprises the step of associating verified results of “PASS” and “FAIL” with said testing files.

10. The method as described in claim 7, wherein each of said static and dynamic test data is transmitted to a shop floor control (SFC) system for processing, and is transmitted to a computer independent from said SFC system and data-communicable therewith for said display in said processing step.

11. A method for testing and repairing a circuit assembly, comprising the steps of:
scanning barcodes for identifying a circuit assembly to be tested;
testing said circuit assembly under control of a first computing system;
transmitting said scanned barcodes and test data from said testing of said circuit assembly to a second computing system independent from said first computing system;
processing said scanned barcodes and test data via said second computing system;
displaying said processed test data in said first computing system when said processed test data is transmitted to said first computing system; and
repairing said circuit assembly based on said test data of said circuit assembly transmitted to a third computing system independent from said first and second computing systems when said circuit assembly is identified as faulty and moved for repair.
